(19) United States
(12) Patent Application Publication
(10) Pub. No.: US 2009/0157828 A1
(43) Pub. Date: Jun. 18, 2009

(54) TECHNIQUES FOR SPECIFYING RECIPIENTS IN AN ELECTRONIC MAIL (EMAIL) SYSTEM

(76) Inventor: Sumit Kumar Agrawal, Bangalore (IN)

Correspondence Address: SCHWEGMAN, LUNDBERG & WOESSNER/NOVELL, PO BOX 2938, MINNEAPOLIS, MN, 55402, US

(21) Appl. No.: 12/050,467

(22) Filed: Mar. 18, 2008

(30) Foreign Application Priority Data
Dec. 12, 2007 (IN) 2602/DEL/2007

(51) Int. Cl. G06F 15/16

(52) U.S. Cl. 709/206

(57) ABSTRACT

Techniques for specifying recipients in an electronic email (email) system are presented. A sender of an email includes a rule in a sender field of the email, rather than a recipient address, an alias address book identifier, or a distribution list identifier. The rule is evaluated to dynamically identify multiple recipient email addresses for the email. The multiple recipient email addresses then replace the rule included within the sender field and the email is sent over a network to recipients associated with the multiple recipient email addresses.

### RELATED APPLICATIONS

This application claims the benefit of priority to India Patent Application No. 2602/DEL/2007 filed in the India Patent Office on Dec. 12, 2007 and entitled “TECHNIQUES FOR SPECIFYING RECIPIENTS IN AN ELECTRONIC MAIL (EMAIL) SYSTEM;” the disclosure of which is incorporated by reference herein.

### BACKGROUND

Electronic mail (email) has become the lifeblood of modern-day communication. In fact, many individuals now possess mobile phones that can send and receive email. Businesses conduct affairs via emails; governments communicate via emails; and individuals engage in personal affairs via emails. It is now hard to imagine a day occurring without email. Email is more pervasive than television and phone communications.

Just about every email system includes a feature for an email sender to define one or more recipients to an email. Typically, a user either types in an email address or types in a distribution list name. A user can even define common names (which are included in the user's address book) that the email system expands into a needed email address when the user enters the common name into a send field of an email.

However, if a user mistypes even a single letter in an email, distribution list, or common aliased name, then the email system will send the email to an incorrect recipient. Additionally, in cases where a user wants to combine selective recipients from different distribution lists, the user is forced to manually identify the email addresses. It may also be that attributes associated with recipients are desired by the user, such as when the user wants to send an email to all engineering managers when there is no existing email distribution list that defines such a grouping. In such a situation, the user will again have to either manually create a distribution list or manually enter each recipient email that the user wants to send an email to.

In fact, existing email systems permit recipients to be defined in the sending fields (TO, CC, BCC) by three techniques: manual email entry, use of a predefined distribution list, and/or use of a predefined alias housed in a user's address book. This is a static approach and does not adequately reflect how a user may want to actually define recipients for an email. That is, different conditions, circumstances, etc. may create a situation where the user needs to dynamically define recipients that are resolved in real time by the email system. But, existing email systems do not have such features.

Thus, what is needed is an improved mechanism for specifying email recipients in email systems.

### SUMMARY

In various embodiments, techniques for specifying recipients in an electronic mail (email) system are provided. More specifically, and in an embodiment, a method is presented for extending features of an email system's send fields. A rule is detected in a send field of an electronic mail message (email). The rule is processed to identify one or more recipient email addresses for the email. Finally, the send field is modified by replacing the rule with the one or more recipient email addresses.

### BRIEF DESCRIPTION OF THE DRAWINGS

FIG. 1 is a diagram of a method for extending features of an email system's send fields, according to an example embodiment.

FIG. 2 is a diagram of another method for extending features of an email system's send fields, according to an example embodiment.

FIG. 3 is a diagram of an extended email send feature system, according to an example embodiment.

FIG. 4 is a diagram of another extended email send feature system, according to an example embodiment.

### DETAILED DESCRIPTION

Various embodiments of this invention can be implemented in existing network architectures, security systems, email systems, data centers, and/or communication devices. For example, in some embodiments, the techniques presented herein are implemented in whole or in part in the Novell® email systems, proxy server products, operating system products, data center products, and/or directory services products distributed by Novell®, Inc., of Provo, Utah.

Of course, the embodiments of the invention can be implemented in a variety of architectural platforms, operating and server systems, devices, emails systems, or applications. Any particular architectural layout or implementation presented herein is provided for purposes of illustration and comprehension only and is not intended to limit aspects of the invention.

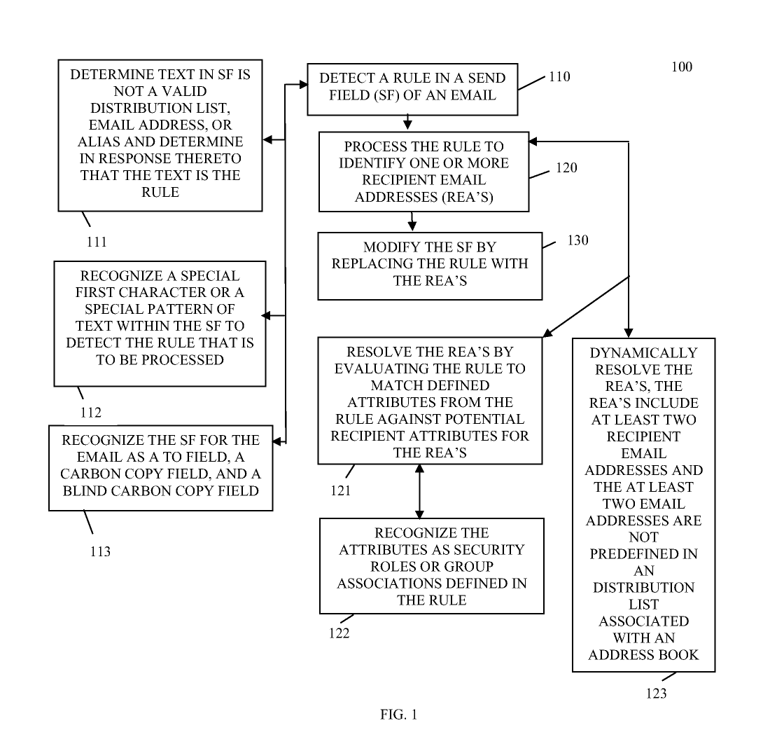

FIG. 1 is a diagram of a method 100 for extending features of an email system's send fields, according to an example embodiment. The method 100 (hereinafter “email recipient resolution service”) is implemented as instructions in a machine-accessible and readable medium. The instructions when executed by a machine perform the processing depicted in FIG. 1. The email recipient resolution service is also operational over and processes within a network. The network may be wired, wireless, or a combination of wired and wireless.

In an embodiment, the email recipient resolution service is implemented in both an email client and email server for an email system. That is, any existing email system is modified with the teachings presented herein to achieve the processing associated with the email recipient resolution service; the modification occurs in both the email client and the email server.

In other cases, it may be that before emails are forwarded to recipients over a network, such as the Internet, the emails must pass through an email server. In such a case, the email client may be designed to ignore the usage of rules within send fields of emails (discussed in detail below) and forward the emails to the email server for processing. In such a case, it may be that the email recipient resolution service is exclusively or primarily implemented in the email server.

At 110, the email recipient resolution service detects a rule in a send field of an email. The email is received via an email client and is constructed by a sender of the email. The sender desires to send the email to zero or more predefined recipients and some recipients that are not resolved as of yet when the email recipient resolution service receives the email for processing. The recipients that are unresolved are ultimately dynamically resolved by the email recipient resolution service once the rule is evaluated and processed in the manners defined herein and below.

According to an embodiment, at 111, the email recipient resolution service determines that test in the send field of the email is not valid or not recognized. In other words, the rule is not associated with any predefined and known email address, known alias, or known distribution list. In response to not be able to associate the text with any predefined address in the send field of the email, the email recipient resolution service determines the unrecognized text is the rule that needs evaluated and processed.

In another case, at 112, the email recipient resolution service recognizes a special first character or a special pattern of text within the send field to detect the rule that is to be processed as discussed more completely below.

In an embodiment, at 113, the email recipient resolution service recognizes the send field for email as a TO field, a carbon copy (CC) field, and a blind carbon copy (BCC) field. In fact, any field within metadata associated with the send field of the email that is used to define recipients via recipient email addresses can be parsed to detect the rule.

Once the rule is detected, the email recipient resolution service, at 120, processes the rule to identify one or more recipient email addresses. The rule is dynamically evaluated for purposes of resolving the one or more recipient email addresses.

In an embodiment, at 121, the email recipient resolution service resolves the recipient email addresses by dynamically evaluating the rule to match defined attributes from the rule against potential recipient attributes for the recipient email addresses or recipients associated with those email addresses.

In a particular case, at 122, the email recipient resolution service recognizes the attributes as security roles or group associations defined within the rule.

Additionally, in some cases, at 123, the email recipient resolution service dynamically resolves the recipient email addresses and those email addresses include at least two recipient email addresses. These two email address are not predefined in any manner in a distribution list associated with an address book of the sender.

At 130, the email recipient resolution service modifies the sender field by replacing the rule with the recipient email addresses. So, unresolved email addresses for the email are dynamically determined and populated into the send field of the email on behalf of the user.

Consider the following example situations. Suppose the sender included the following rule in the send field: “Department=SRM-IDC && Title=!Trainee and EmpType!=Contract.” Here, the rule includes a variety of conditions, the first condition is to include recipient email addresses that have an attribute limitation associated with a role or group association that defines a department of “SRM-IDC;” the subsequent conditions include AND NOT conditions that include recipients with a title of Trainee and an EmpTYPE (employee type) of Contract.

In the example, the sender (user) wants to send the email to every recipient having a role of SRM-IDC and wants to further exclude or remove any recipient having a title of trainee or employee type of contract.

This example situation is not possible with conventional email systems because the send fields can only accept predefined known entries in an address book. These predefined known entries consists of three types, regular email addresses, aliases that map in the address book to regular email addresses, and distribution lists that map in the address book to multiple different email addresses. Conventional email systems do not permit and will not recognize and process dynamic rules contained within a sender field.

Various modifications can also be included to the approach discussed above. For example, the email recipient resolution service may permit a new field within the metadata not directly associated with the send fields, such that when a rule is present in this new field. The email recipient resolution service dynamically modifies or overrides completely the recipients defined in the send fields with the recipient email addresses resolved by dynamically evaluating the rule of the new field.

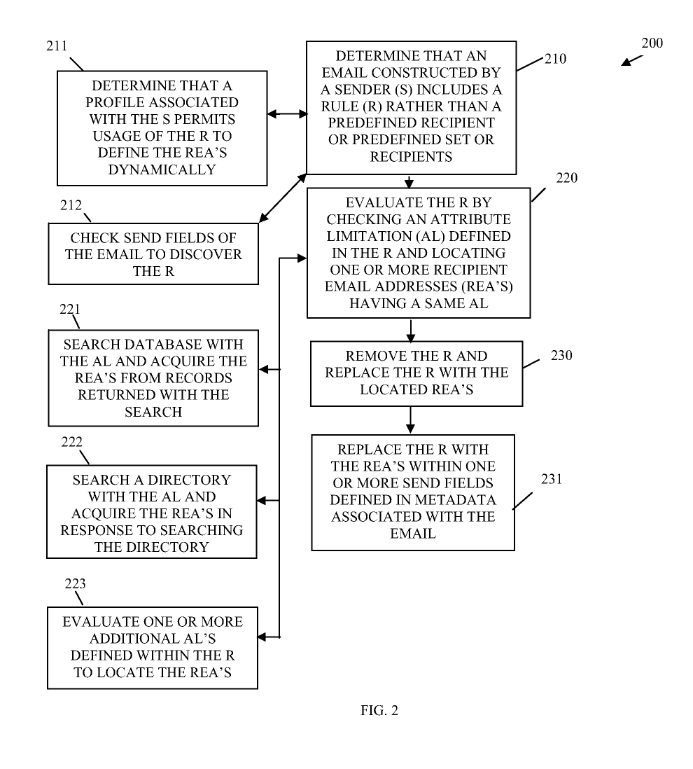

FIG. 2 is a diagram of another method 200 for extending features of an email system's send fields, according to an example embodiment. The method 200 (hereinafter “email send extended feature service” is implemented in a machine-accessible and readable medium as instructions. The instructions when executed by a machine perform the processing depicted in the FIG. 2. Moreover, the email send extended feature service is operational over a network, and the network may be wired, wireless, or a combination of wired and wireless.

The processing associated with the email send extended feature service represents an enhanced and in some cases more detailed perspective of the email recipient recognition service represented by the method 100 and described within the context of the FIG. 1.

At 210, the email send extended feature service determines that an email constructed by a sender includes a rule, rather than a predefined recipient or predefined set of recipients (such as a conventional distribution list).

In some cases, at 211, the email send extended feature service only permits a rule in the sender field of metadata associated with an email when a profile or policy associated with the sender permits usage of the rule to dynamically define and resolve recipient email addresses for the email. Such a feature may be particularly useful to up sell an added feature to an email system to specific users or senders that have purchased this feature. It may also only be desirable to permit selective users within an enterprise to have such a feature. So, by tying a policy or a profile of a particular sender to the ability to use the feature some custom benefits and custom security can be achieved.

According to an embodiment, at 212, the email send extended feature service checks send fields housed within metadata of the email to discover the rule. Again, the send fields can be a TO field, a CC field, a BCC field, or a custom field in an email system that is used for identifying email addresses.

At 220, the email send extended feature service evaluates the rule by checking an attribute limitation defined in the rule and locating one or more recipient email addresses having a same attribute limitation. In other words, the limitations defined in the rule are matched to limitations associated with recipients. The recipients include other attributes, such as the recipient email addresses so that the email send extended feature service can acquire the needed email addresses to populate in the send field of the email. This permits the email to be properly processed and forwarded to the recipients when pushed out over the network.

According to an embodiment, at 221, the email send extended feature service searches a database with the attribute limitations to acquire the recipient email addresses from records returned with the search. So, the database may be a relational database and the rule is defined in a Structured Query Language (SQL). This permits the email send extended feature service to perform a SQL search and parse the resulting records of the answer set to acquire the recipient email addresses.

In another case, at 222, the email send extended feature service searches a directory with the attribute limitation and then acquires the recipient email addresses in response to searching the directory. For example, the rule may be in a format defined for a Lightweight Directory Access Protocol (LDAP) database or data store. So, the email send extended feature service can process LDAP searches in response to the rule to locate the needed recipient email addresses.

In an embodiment, at 223, the email send extended feature service evaluates one or more additional attribute limitations that are also defined in the rule to locate the recipient email addresses. So, as with the example presented above with reference to the method 100 of the FIG. 1 multiple attribute limitations can be included in the rule and processed by the email send extended feature service. In fact, multiple rules may exist and be processed in multiple send fields of the email.

At 230, the email send extended feature service removes the rule and replaces the rule with the located recipient email addresses.

In an embodiment, at 231, the email send extended feature service replaces the rule with the recipient email addresses within the one or more send fields defined in metadata associated with the email.

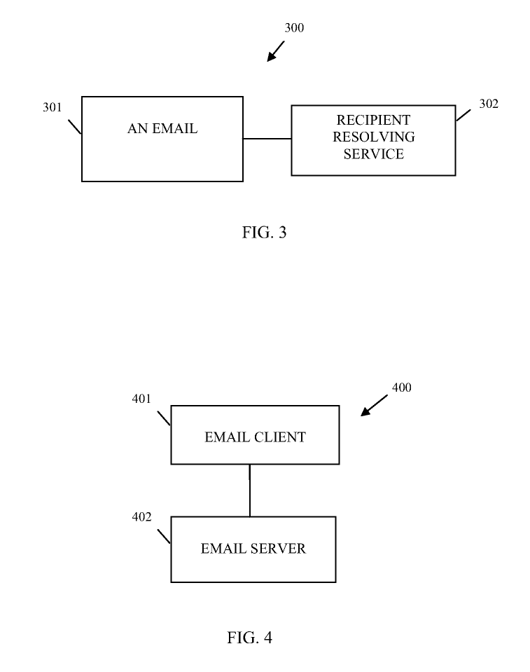

FIG. 3 is a diagram of an extended email send feature system 300, according to an example embodiment. The extended email send feature system 300 is implemented as instructions on or within a machine-accessible and readable medium. The instructions when executed by a machine perform processing depicted with respect to the method 100 of the FIG. 1 and the method 200 of the FIG. 2. The extended email send feature system 300 is also operational over a network and the network may be wired, wireless, or a combination of wired and wireless. In some cases the network is the Internet or a wide-area network (WAN).

The extended email send feature system 300 includes an email 301 and a recipient resolving service 302. Each of these will now be discussed in turn.

The email 301 is implemented in a machine-accessible and computer-readable medium and is accessible to and preprocessed by the recipient resolving service 302. The recipient resolving service 302 processes on a machine (processing device, computer, email enabled device, etc.), such as an email client and/or an email server.

The email 301 includes one or more send fields, such as a TO filed, a CC field, a BCC field, or custom defined field defined in and permissible within the email system that includes the enhancement that implements the extended email send feature system 300.

The recipient resolving service 302 is implemented in a machine-accessible and computer-readable medium and processes on a machine, such as an email client or an email server. In some cases, the email send extended feature service 302 is implemented in both the email client and email server and thus can process on two different machines over the network, such as but not limited to the Internet. Example processing associated with the recipient resolving service 302 was presented in detail above with reference to the methods 100 and 200 of the FIGS. 1 and 2, respectively.

The recipient resolving service 302 dynamically resolves multiple recipient email addresses by evaluating a rule that is defined in the one or more send fields of metadata associated with the email 301. The recipient resolving service 302 replaces the rule with multiple dynamically resolved recipient email addresses before sending the email over the network.

In an embodiment, the recipient resolving service 302 performs a query against a database using limitations defined in the rule to acquire search results. The search results represents records for recipients and the recipient resolving service 302 acquires the multiple recipient email addresses from the records.

The limitations define attribute limitations, which are represented in the rule and which match the recipient limitations defined in the records.

In a particular situation, the limitations define business marketing limitations defined in a marketing campaign of an enterprise. The business marketing limitations match recipient limitations defined in the records discussed above and which are returned with the search results.

So, customer-relationship management can be more easily achieved with the system 300. This is so, because business analysts can include queries for sales, stores, product purchases, etc. in the rule and the marketing information automatically sent to recipients that are retrieved from a database using the query defined as the rule in the send fields of an email. In fact, a front-end interface can also be provided to assist the business analyst in defining the query and then the automatically generated query can be populated to the send field in an automated fashion for the business analyst and resolved to specific customer email addresses by the recipient resolving service 302 embedded within or interfaced to the email system being used by the business analyst.

In still another embodiment, the recipient resolving service 302 determines before performing any preprocessing on the email that a sender associated with the email is permitted via a policy or profile (associated with the sender or a role assigned to the sender) to use the rule for purposes of having the multiple recipient email addresses dynamically resolved by the recipient resolving service 302. The usefulness of this situation was discussed above with reference to the method 200 of the FIG. 2.

FIG. 4 is a diagram of another extended email send feature system 400, according to an example embodiment. The extended email send feature system 400 is implemented as instructions on or within a machine-accessible and readable medium. The instructions when executed by one or more machines also perform, among other things; the processing depicted with respect to the method 100 of the FIG. 1 and the method 200 of the FIG. 2. The extended email send feature system 400 is also operational over a network and the network may be wired, wireless, or a combination of wired and wireless.

The extended email send feature system 400 includes an email client 401 and an email server 402. Each of these will now be discussed in turn.

The email client 401 and the email server 402 combine to form an email system or service.

The email client 401 is implemented in a machine-accessible and computer-readable medium and is to process on a client machine.

The email client 401 and the email server 402 cooperate with one another to evaluate rules defined in send fields of emails being sent from a sender for purposes of dynamically replacing those rules in the send fields with recipient email addresses before forwarding the emails from the sender to recipients associated with the recipient email addresses.

In an embodiment, the email client 401 identifies the rules and alters the email server 402 that the rules are to be dynamically evaluated and processed to substitute the rules with the dynamically resolved recipient email addresses.

In another case, the email client 401 performs some of the replacements for the rules and the email server 402 performs others of the replacements for other rules.

In still another case, the email client 402 forwards the emails to the email server 402 and the email server exclusively performs the needed replacements of the rules with the recipient email addresses in the send fields of the emails.

In fact, a variety of configurations are possible where the email client 401 does each of the replacements, the email server 402 does each of the replacements, and/or both the email client 401 and the email server 402 cooperate and augment one another with each performing some replacements different from the other.

The email server 402 is implemented in a machine-accessible and computer-readable medium and is to process on a server machine.

The email server 402 is responsible for injecting the emails of the sender into the network and forwarding them to the recipients associated with the recipient email addresses.

Both the email server 402 and the email client 401 can include the processing associated with the methods 100 and 200 discussed above in detail with reference to the FIGS. 1 and 2, respectively, and with respect to the recipient resolving service 302 described above with reference to the system 300 of the FIG. 3.

It is now fully appreciated how send fields of email can include more information than what has been conventionally permitted. This additional information can be any rule in any format that permits the rule to be dynamically evaluated in real time to resolve recipient email addresses. The rule is not a traditional distribution list or alias that are defined in conventional email address books; rather the rule is a series of conditions that when evaluated permit proper recipient email addresses to be populated in the email send fields, such that the emails can be handled properly once injected into the network by other disparate and external email systems dispersed over the network.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A machine-implemented method, comprising:
detecting a rule in a send field of an electronic mail message (email);
processing the rule to identify one or more recipient email addresses for the email; and
modifying the send field by replacing the rule with the one or more recipient email addresses.

2. The method of claim 1, wherein detecting further includes determining that text included in the send field is not associated with a valid email address, a valid alias name, and a valid distribution name, and in response thereto determining that the text is to be associated with the rule.

3. The method of claim 1, wherein detecting further includes recognizing a special first character or a special pattern of text within send field to detect the rule that is to be processed.

4. The method of claim 1, wherein detecting further includes recognizing the send field for the email as a to field, a carbon copy field, and a blind carbon copy field.

5. The method of claim 1, wherein processing further includes resolving the one or more recipient email addresses by evaluating the rule to match defined attributes from the rule against potential recipient attributes for the one or more recipient email addresses.

6. The method of claim 5, wherein resolving further includes recognizing the attributes as security roles or group associations defined in the rule.

7. The method of claim 1, wherein processing further includes dynamically resolving the one or more recipient email addresses, and wherein the one or more recipient email addresses include at least two recipient email addresses and the at least two email addresses are not predefined in a distribution list of an address book associated with a sender of the email.

8. A machine-implemented method, comprising:
determining that an electronic email message (email) constructed by a sender includes a rule rather than a predefined recipient or predefined set of recipients;
evaluating the rule by checking an attribute limitation defined in the rule and locating one or more recipient email address having a same attribute limitation; and
removing the rule and replacing the rule with the one or more located recipient email addresses.

9. The method of claim 8, wherein determining further includes checking send fields of the email to discover the rule in the email.

10. The method of claim 8, wherein evaluating further includes searching a database with the attribute limitation and acquiring the one or more recipient email addresses from records returned in response to the searching, wherein each record is a particular recipient.

11. The method of claim 8, wherein evaluating further includes searching a directory with the attribute limitation and acquiring the one or more recipient email addresses in response to the searching of the directory.

12. The method of claim 8, wherein evaluating further includes evaluating one or more additional attribute limitations defined within the rule to locate the one or more recipient email addresses.

13. The method of claim 8, wherein removing further includes replacing the rule with the one or more recipient email address within one or more send fields defined in metadata associated with the email.

14. The method of claim 8 further comprising, determining that a profile associated with the sender permits usage of the rule to define the one or more recipient email addresses dynamically.

15. A system, comprising:
an electronic mail message (email) residing in a machine-accessible and computer-readable medium and accessible to and preprocessed by a recipient resolving service that executes on a machine;
the recipient resolving service implemented in a machine-accessible and computer-readable medium and to process on the machine;
wherein the recipient resolving service dynamically resolves multiple recipient email addresses by evaluating a rule defined in one or more send fields of metadata associated with the email and replaces the rule with the multiple recipient email address within the metadata before sending the email over a network.

16. The system of claim 15, wherein the one or more send fields include a to field, a carbon copy field, and a blind carbon copy field.

17. The system of claim 15, wherein the recipient resolving service performs a query against a database using limitations defined in the rule to acquire search results representing records for recipients and wherein the recipient resolving service acquires the multiple recipient email addresses from the records.

18. The system of claim 17, wherein the limitations define attribute limitations defined in the rule that match recipient limitations defined in the records.

19. The system of claim 17, wherein the limitations define business marketing limitations defined in a marketing campaign, and wherein the business marketing limitations match recipient limitations defined in the records.

20. The system of claim 15, wherein the recipient resolving service determines before preprocessing the email that a sender associated with the email is permitted via a policy or a profile associated with the sender to use the rule to dynamically have the multiple recipient email addresses resolved for the sender.

21. A system, comprising:
an electronic mail message (email) client implemented in a machine-accessible and computer-readable medium and is to process on a client machine; and
an email server implemented in a machine-accessible and computer-readable medium and is to process on a server machine;
wherein the email client receives emails from a sender having rules defined in send fields of those emails and cooperates with the email server to evaluate the rules and dynamically replace the rules in the send fields with recipient email addresses before forwarding the emails from the sender to recipients associated with the recipient email addresses.

22. The system of claim 21, wherein the email client identifies the rules and alerts the email server that the rules are to be dynamically evaluated and processed to substitute the recipient email addresses.

23. The system of claim 21, wherein the email client performs some of replacements and the email server performs others of the replacements.

24. The system of claim 21, wherein the email client forward the emails to the email server and the email server performs the replacements.
